(19) United States
(12) Patent Application Publication
(10) Pub. No.: US 2020/0186813 A1
(43) Pub. Date: Jun. 11, 2020

(54) SYSTEM AND METHOD FOR COMPRESSING DATA USING A FILTER WITHOUT LOSS OF CRITICAL DATA

(71) Applicant: Samsung Electronics Co., Ltd., Suwon-si (KR)

(72) Inventor: Nicholas C. Fishwick, San Francisco, CA (US)

(21) Appl. No.: 16/422,194

(22) Filed: May 24, 2019

Related U.S. Application Data
(60) Provisional application No. 62/775,773, filed on Dec. 5, 2018.

(51) Int. Cl. H04N 19/42; G06K 9/32; G06K 9/46; G06T 7/50; G06T 7/70

(52) U.S. Cl. CPC H04N 19/439; G06K 9/3233; G06K 9/4609; G06T 2207/30252; G06T 7/70; G06T 2210/12; G06T 7/50

(57) ABSTRACT

An apparatus includes: an interface configured to receive an image data; a memory configured to store the image data; and a processor configured to run an application to determine one or more regions of interests (ROIs) within the image data. The processor generates a compressed image data by selectively applying a first data compression to the one or more ROIs and a second data compression to regions of the image data except the one or more ROIs.

### CROSS-REFERENCE TO RELATED APPLICATION(S)

This application claims the benefits of and priority to U.S. Provisional Patent Application Ser. No. 62/775,773 filed Dec. 5, 2018, the disclosure of which is incorporated herein by reference in its entirety.

### TECHNICAL FIELD

The present disclosure relates generally to a system and method for data compression, more particularly, to a system and method for applying selective data compression schemes based on object classification and regions of interest.

### BACKGROUND

In autonomous driving, a lot of informational data of high-bandwidth is captured using various types of sensors such as a video camera, a LiDAR, a radar, etc. and sent as raw data to multiple data processing units over in-car data communication paths. The transfer of the raw data typically requires a very high-bandwidth and takes up a lot of computing resources. In order to cut the cost of computing resource usage, and prevent slowdown of a system, the raw data may be transferred as being compressed. Data compression may cause a loss of information, and the lost information can be critical for applications such as autonomous driving.

### SUMMARY

According to one embodiment, an apparatus includes: an interface configured to receive an image data; a memory configured to store the image data; and a processor configured to run an application to determine one or more regions of interests (ROIs) within the image data. The processor generates a compressed image data by selectively applying a first data compression to the one or more ROIs and a second data compression to regions of the image data except the one or more ROIs.

According to another embodiment, a method includes: receiving an image data; running an application to determine one or more regions of interests (ROIs) within the image data; and generating a compressed image data by selectively applying a first data compression to the one or more ROIs and a second data compression to regions of the image data except the one or more ROIs.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of the present disclosure.

### BRIEF DESCRIPTION OF THE DRAWINGS

The accompanying drawings, which are included as part of the present specification, illustrate the presently preferred embodiment and together with the general description given above and the detailed description of the preferred embodiment given below serve to explain and teach the principles described herein.

FIG. 1 shows a block diagram of the present system according to one embodiment;

FIG. 2 shows an example of regions of interest within an image, according to one embodiment;

FIG. 3 illustrates an example of applying data compression to the image shown in FIG. 2, according to one embodiment;

FIG. 4 shows an example of applying a lossy data compression to the entire raw image data, according to one embodiment;

FIG. 5 shows an example of progressive ROI prioritization, according to one embodiment;

FIG. 6 shows an example of ROIs that change their priorities and sizes based on the time progression, according to one embodiment;

FIG. 7 shows an example of an ROI that changes based on an object trajectory, according to one embodiment;

FIG. 8 shows example of a data compression apparatus that includes a pass filter according to one embodiment;

FIG. 9 shows comparative results of filtering using only image data and image data with depth data according one embodiment;

FIG. 10 shows a block diagram in which multiple data tracks are continuously fed to an apparatus for data compression, according to one embodiment;

FIG. 11 shows a block diagram in which multiple devices feed data to a mixer for generating an encoded data, according to one embodiment; and

FIG. 12 shows a block diagram of an example system, according to one embodiment.

The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

### DETAILED DESCRIPTION

Each of the features and teachings disclosed herein can be utilized separately or in conjunction with other features and teachings to provide a system and method for applying selective data compression schemes based on object classification and regions of interest. Representative examples utilizing many of these additional features and teachings, both separately and in combination, are described in further detail with reference to the attached figures. This detailed description is merely intended to teach a person of skill in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present disclosure. However, it will be apparent to one skilled in the art that these specific details are not required to practice the teachings of the present disclosure.

Some portions of the detailed descriptions herein are presented in terms of algorithms and symbolic representations of operations on data bits within a computer memory. These algorithmic descriptions and representations are used by those skilled in the data processing arts to effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of an original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

The present disclosure provides a system and method for compressing a size of raw data (e.g., image data as captured by a video camera) while maintaining critical information such that a bandwidth for transferring the data can be reduced.

The present system and method effectively and adaptively combines lossless and lossy data compression for the raw data captured using various sensory devices such as a video camera, a LiDAR, a radar, or the like. By combining lossless and lossy data compression intelligently, the present system and method can achieve a greater integrity for preserving critical information from the raw data and reduce the bandwidth and the cost of computing the data.

According to one embodiment, the present system and method employs an adaptive data compression together along with an object detection scheme and a path planning scheme. The object detection scheme creates an overlay of lossless data for carrying critical information that may be interest and uses lossy compression only on non-critical portion of the data. The path planning scheme detects an object trajectory to improve data prioritization and filtering degradation.

The present system and method can be applied to various data-critical applications such as autonomous driving. The present system and method can provide saving of data bandwidth, computing resources, and costs while increasing integrity and safety by removing uncertainties.

According to one embodiment, the present system and method can optimize size and movement of data (e.g., image data or video data) captured with sensors. The captured data is sent from the sensors to one system-on-chip (SOC) and may be shared with other SOCs in the system across data communication paths. For example, a first SOC may receive video data (or a stream of image data) from a video camera, compress the video data, and send the video data to a second SOC via an interconnect path (e.g., Internet Protocol (IP) or Peripheral Component Interconnect Express (PCIe)). The second SOC may be an accelerator such as a graphic processing unit (GPU) and neural processing unit (NPU) for processing the video data using various data processing schemes such as Deep Neural Network (DNN) or Convolutional Neural Network (CNN).

In a conventional heterogeneous computing solution, the first SOC may run a first application (herein also referred to as a first algorithm), and the second SOC may run second application (herein also referred to as a second algorithm) separately and/or independently from the first SOC. In this case, an actual location of the applications can be abstracted throughout the system including the first and second SOCs, but the present disclosure is not limited thereto. Certain data processing schemes, for example, DNN or CNN, may need to consume raw data requiring movement of the raw or compressed data from the first SOC to the second SOC. When the raw data is transferred as being compressed, data compression may not be compatible and work efficiently with certain data processing schemes due to the lossy data compression. Furthermore, transferring the raw data can be expensive because it requires much data bandwidth and/or computing resources. The present system and method can adaptively and intelligently compress raw data, not just non-critical portion of the raw data, and thereby preventing possibly loss of critical information while achieving reduction of data bandwidth and consumption of computing resources.

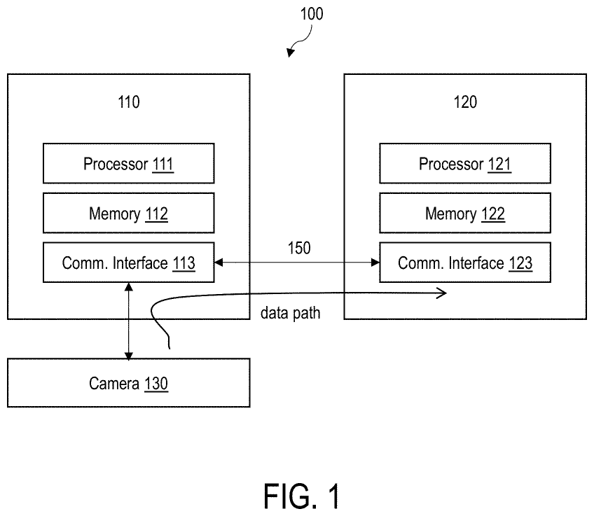

FIG. 1 shows a block diagram of an example system according to one embodiment. A system 100 includes electronic devices 110 and 120. Each of the electronic devices 110 and 120 may include a processor, a memory, and a communication interface. In the present example, the electronic device 110 includes a processor 111, a memory 112, and a communication interface 113 via which the electronic device 110 can receive data from a camera 130. The data received from the camera 130 may be a raw data in various formats, for example, MOV, MP4, and AVI. The raw data may be stored in the memory 112 of the electronic device 110, and the processor 111 of the electronic device 110 may run a first application to process the raw data and transfer either the raw data received from the camera 130 or the processed data to other electronic devices in the system including the electronic device 120 via the communication interface 113. Similar to the electronic device 110, the electronic device 120 includes a processor 121, a memory 122, and a communication interface 123 via which the electronic device 120 can exchange data with the communication interface 113 of the electronic device 110. The electronic device 120 may run a second application to process the data received from the first electronic device 110. The first application running on the electronic device 110 and the second application running on the electronic device 120 may correspond to threads or processes of a single application. In this case, the first application and the second application may collaboratively exchange data for processing their own threads or processes independently from each other. In one embodiment, the raw data is processed at a processor that is physically near the camera 130 to reduce the amount of data being transferred and the latency and overhead of transferring the raw data over a data communication path.

According to one embodiment, the first application running on the first electronic device 110 identifies one or more regions of interest (ROIs) within the raw data that is received from the camera 130 and segments them based on user-defined priorities and conditions. For example, an autonomous driving application identifies pedestrians, bicyclists, motorcycles, cars, trucks, lanes, traffic lights, signs, trees, bridges, traffic islands, or any other indicator that may be of an interest for precisely controlling and navigating a self-driving vehicle avoiding cars, people, and obstacles.

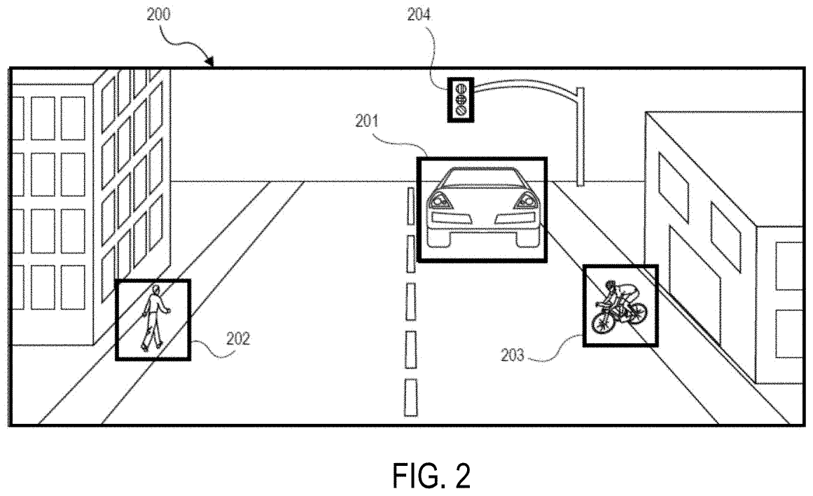

FIG. 2 shows an example of regions of interest within an image, according to one embodiment. An image 200 is captured using a video camera. Within the image 200, there are several ROIs including a car 201, one or more people 202 and 203, a traffic light 204. It is understood that this is only an example, and the image 200 may include different number and kinds of ROIs therein. In some embodiment, the ROIs may be determined based on the closeness to the electronic device 110 or the camera 130. For example, regions of cars, people, and traffic lights that are farther from the camera 130 may not be classified as an ROI because they do not pose a potential danger or generate a warning and do not require immediate attention to the self-driving vehicle.

After the ROIs are identified, the first application may generate information regarding the ROIs, herein also referred to as ROI information or ROI data, within the frame of the raw image data. For example, the ROI information may be in the form of a metadata that identifies a shape (e.g., a bounding box or a bounding shape that is obtained by edge detection), size, and position or coordinate within the raw data. The metadata may be used to reconstruct the raw image data with reduced resolution in the areas.

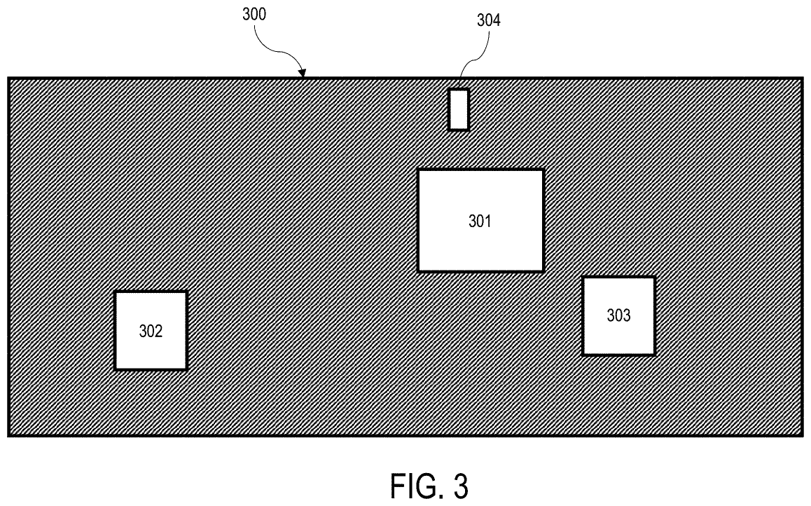

FIG. 3 illustrates an example of applying data compression to the image shown in FIG. 2, according to one embodiment. A compressed image 300 includes the ROIs 301, 302, 303, and 304 that correspond to the car 201, the people 202 and 203, the traffic light 204 of FIG. 2. The compressed image 300 is obtained by selectively applying data compression to the image 200. In one embodiment, a lossless data compression is applied to the ROIs whereas a lossy data compression is applied to regions other than ROIs. In this case, the critical information of the ROIs may be maintained without a loss even after the data compression.

According to one embodiment, the camera 130 may have a data processing and compression facility to at least partly process and/or compress the raw images of a video stream as they are being captured and send a pre-processed data (as opposed to the raw data). The pre-process data may include metadata corresponding to the ROIs.

The first application that can segment ROIs from the raw image data may a classification application. For example, an image (e.g., a video capture or a snapshot of a video stream) including a person in it shows that person is close enough to be an object of interest, classification application may define a bounding box around the person and classify it an ROI. There may be more ROIs. In the example shown in FIG. 2, there are four ROIs. Areas other than the ROIs may not contain critical information. It is noted that an ROI does not have to identified as a bounding box. For example, an ROI can be a bounding shape of a box, a circle, or any shape and sizes.

According to one embodiment, the first application may work with an external classification application to identify objects based on a list of interests. For example, the first application identifies itself ROIs and provides the metadata of the ROIs to the external classification application. The external classification application may further refine the classification and feed the updated metadata of the ROIs back to the first application. The first application may dynamically update the list of interests used for classification of objects based on the updated metadata of the ROIs. In this regard, the first application may process the raw data based on a set of rules for classification, and the set of rules for classification may be constantly updated based on learning (e.g., DNN, CNN) by the external classification application. In some embodiments, the first application itself can include the capability and facility to perform the learning and update and refine the algorithm for object classification.

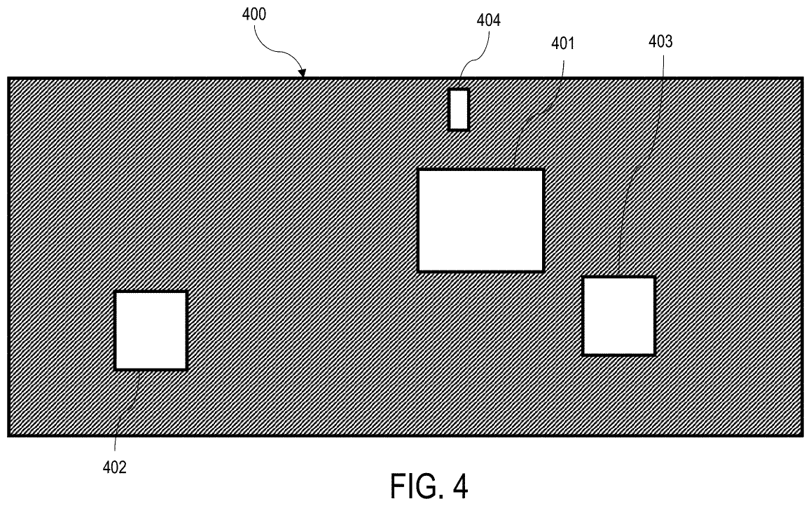

As a comparative example, FIG. 4 shows an example of applying a lossy data compression to the entire raw image data, according to one embodiment. A compressed image 400 includes the ROIs 401, 402, 403, and 404 that correspond to the car 201, the people 202 and 203, the traffic light 204 of FIG. 2. The lossy data compression may compress data that may include critical information corresponding to the ROIs 401-404, therefore it is possible to lose some critical information or fidelity that may be necessary for other applications to process the critical information of the ROIs 401-404. In some embodiment, a first lossy data compression may be applied to the ROIs, and a second lossy data compression may be applied to the rest of the areas of the image. The first lossy data compression may compress data with a higher resolution or fidelity but it may retain the critical information of the ROIs better than the second lossy compression applied to the rest of the areas while reducing the size of the data corresponding to the ROIs. In some embodiments, the lossless data compression may not be always necessary to obtain the results of retaining critical information corresponding to the ROIs. Depending on the bandwidth requirement that may be dynamically changing, the first application may change the level of data compression, whether it is lossy or lossless, on the fly to reflect the dynamically changing bandwidth requirement.

According to one embodiment, the first application subscribes to the data received from the camera 130, determines the ROIs, and may overlays other information for the ROIs using an overlay filter.

According to one embodiment, the first application segments the ROIs from the raw image data based on a depth map. The depth map may be used to help identifying the ROIs in the raw data such as an image of a video stream. An external device (not shown) such as a LiDAR, a radar, or a stereoscopic video camera may generate the depth map and feed it to the first electronic device 110.

The field of view that the depth map covers may not correspond to the field of view of the camera 130. In this case, the depth may be correlated to the image data via a mapping between the field of views of the camera 130 and the external device that provides the depth map. In some embodiments, the first application may combine multiple depth map data having different data formats that are received from multiple devices and identify the ROIs based on the combination of the depth map data. The priority of the ROIs may be determined based on the closeness to the camera 130 or the self-driving car equipped with the camera 130.

The depth map may be useful for determining whether candidate areas of interest are in a foreground or in a background of the image. Only an area of an interest in the foreground, i.e., areas close to the camera 130 or a self-driving vehicle equipped with the camera 130, may be classified as an ROI having a higher interest whereas the areas in the background may be classified as an area of no interest or a lower interest. A depth filter may be used to filter the high interest areas from the low interest areas. The depth filter may apply a user-definable and programmable threshold to filter the high interest areas from the low interest areas. For example, the regions that are within a certain distance from the camera 130 or the self-driving vehicle equipped with the camera 130 may be classified as ROIs.

After the ROIs are determined, the depth information may be used to prioritize the data compression for the ROIs. The data compression may be applied with a high priority for the ROIs for data integrity and apply lower priority for the non-ROIs. The priorities to the ROIs and non-ROIs may not have to be binary, and the priories may be applied progressively based on the depth information. For example, a first ROI that is closest to the camera 130 may be given the highest priority, a second ROI that is farther than the first ROI may be given a second highest priority, etc. A region that is farther than the ROIs may be given the same level of data (lossy) compression.

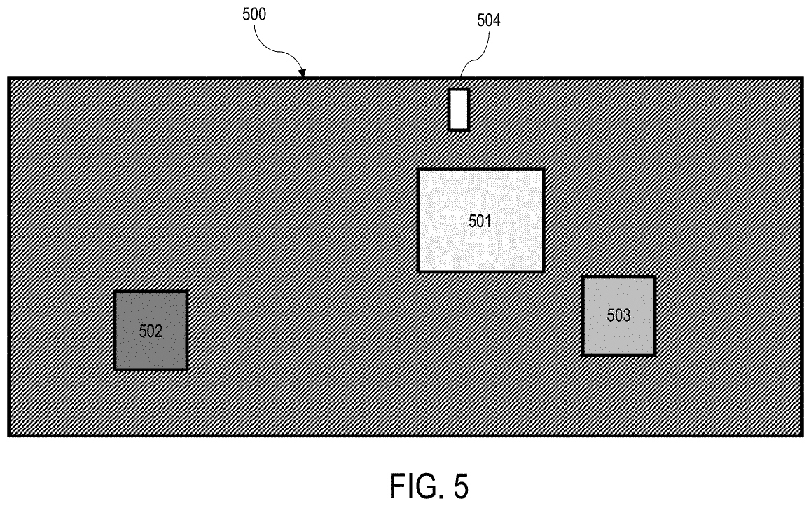

According to one embodiment, the present system and method may apply progressive ROI data prioritization. FIG. 5 shows an example of progressive ROI prioritization, according to one embodiment. A prioritized image 500 includes the ROIs 501, 502, 503, and 504 that correspond to the car 201, the people 202 and 203, the traffic light 204 of FIG. 2. By creating a data integrity map, the priority for data integrity goes down as an object is farther away from the camera 130, and the priority for data integrity goes up as an object is closer to the camera 130. In the present example, a priority filter may classify the ROI 502 that is closest as the highest priority, the ROI 503 as the second highest priority, the ROI 501 as the third highest priority, etc. based on the closeness to the camera 130. The priority filter may apply different level of data compression based on the priorities of the ROIs. In one embodiment, the priority filter may apply different priorities based on the closeness. In another embodiment, the priority filter may apply different priorities to the ROIs based on the classification of the ROIs. For example, the priority to the ROI 504 corresponding to the traffic light may be given a higher priority than other objects closer to the camera due to the criticality of the information that the ROI 504 would provide. Moving objects such as cars, trucks, and motorcycles, may be given a first category of priorities, and people may be given another category of priorities.

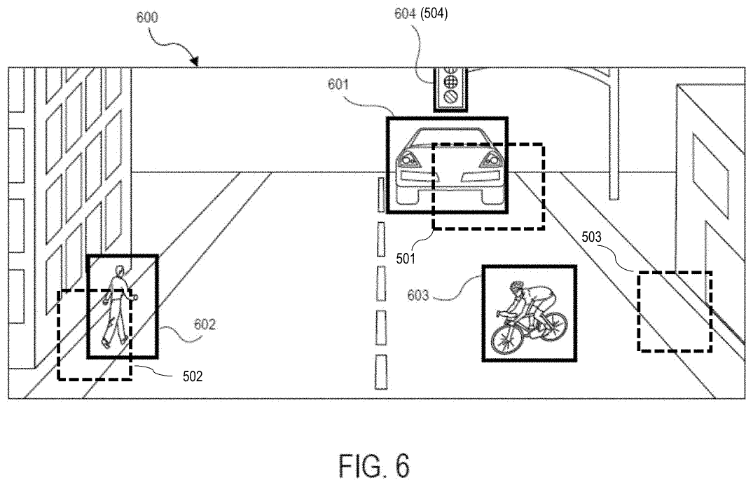

A passage of time may affect the prioritization of the ROIs. FIG. 6 shows an example of ROIs that change their priorities and sizes based on the time progression, according to one embodiment. The image 200 shown in FIG. 2 may be captured at t0, and an image 600 of FIG. 6 may correspond to an image that is captured at t1 after t0. The image 600 includes the ROIs 601, 602, 603, and 604 that correspond to the car 201, the people 202 and 203, the traffic light 204 of FIG. 2. As time progresses, the relative positions of the ROIs with respect to the camera 130 change. Non-moving standing objects such as the ROI 604 of the traffic light 204 may change its size as the camera 130 moves. Other moving objects within the ROIs 601, 602 and 603 may get closer or farther from the camera 130, therefore the sizes of the ROIs may naturally change even without a movement of the objects within the ROIs. If an object within an ROI moves, the ROI may further change their sizes due to the movement of the camera 130 as well as the movement of the object within the ROI as well. As a result, the level of certainties (or uncertainties) of the ROIs may change accordingly as time progresses.

The ROIs 601-604 shows the time progression of the ROIs 501-504 (indicated as boxes of dotted lines). Once the first application identifies that the uncertainty of an ROI increases, the size of ROI may expand. In the present example, the ROI 602 may have an expanded size compared to the size of the ROI 502 due to the increased level of uncertainty. The level of uncertainties may be determined based on various parameters including, but not limited to, a direction and/or trajectory of movement, and a behavior of the objects within the ROI. On the other hand, as the level of certainties for the ROIs (e.g., posing less danger or moving away from the camera 130) increase, the size of the ROIs may shrink as they pose less danger or are of less interest. The expansion or shrinking the ROIs may occur irrespective of the movement of the camera 130 that naturally changes the field of view. In some embodiments, the direction and speed of the movements of the objects within the ROIs may be calculated based on the time-progressed data and level of certainties or uncertainties may be determined based on them.

The performance of data compression may increase or decrease over time as certainties or uncertainties of ROIs go up or down causing expansion or shrinking of the ROIs. In general, ROIs moving closer may expand in all directions unless the direction or trajectory of the movement is determined.

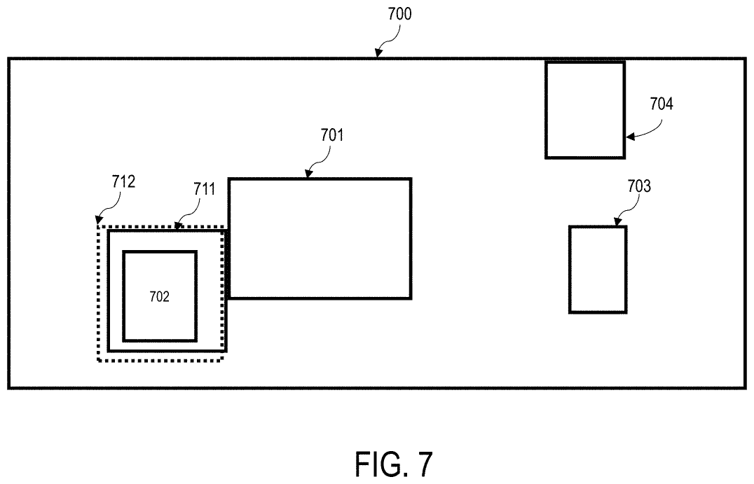

According to one embodiment, a trajectory of an object within an ROI may be used to apply the data prioritization. FIG. 7 shows an example of an ROI that changes based on an object trajectory, according to one embodiment. An image 700 includes ROIs 701, 702, 703, and 704. If a trajectory and/or a direction of an object within an ROI and its speed are determined, the ROI may not need to expand in all directions. According to one embodiment, the ROI 702 may expand to an ROI 711 or an ROI 712 based on the trajectory, direction and/or speed of an object within the ROI 702. This allows efficient data compression because the ROI moving closer may expand only in the direction of movement. The prioritization filter may determine the size and direction of expansion or shrinking of an ROI based on the trajectory, direction, and/or speed information of an object within the ROI, thereby slowing the degradation of the filter while increasing compression performance.

When it is observed that an object within an ROI gets reset turning into a non-ROI, the data compression performance may immediately go up again. The frequency of sub-sampling for determining ROIs and non-ROIs is customizable to the requirements and application of a system. If a camera frame rate is different from the frame rate of a LiDAR or a radar, the sub-sampling may run at a different frequency that the actual video feed frequency. This may introduce uncertainties. Observing every video frame requires a high bandwidth and more computing. The amount of time between sampling may cause uncertainties. Therefore, there is a tradeoff between system resources such as bandwidth and computing and uncertainties. The frequency of sampling may be dynamically changed as the resource availability and/or application requirement change. By optimizing the sampling frequency, the present system and method can enhance the performance of data compression even under a situation of uncertainty exists while lowering the resource usage substantially.

After generating the compressed data as discussed above with reference to FIGS. 3-7, the first electronic device 110 sends the compressed data to the second electronic device 120 for running the second application. The present system and method benefits from the reduced size of the data as well as the frequency of data transfer between the first electronic device 110 and the second electronic device 120.

The present system and method employs efficient data compression, for example, combining both lossless and lossy data compression to compress raw data without losing critical information. Application of the lossless data compression for the ROIs would save from loss of critical information while application of lossy compression for the rest of the areas would save a bandwidth for data transfer without losing context. The amount of reduced bandwidth may depend on the number of ROIs and the algorithm for the lossy data compression.

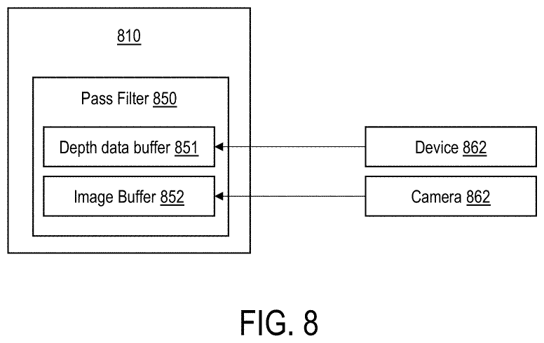

FIG. 8 shows example of a data compression apparatus that includes a pass filter according to one embodiment. The data compression apparatus 810 includes a pass filter 820 that determines ROIs and their priorities based on image received from a camera 862 as discussed above. The image data received from the camera 862 is temporarily stored in an image buffer 852. The pass filter 850 may apply various algorithm to determine ROIs within the image. Examples of such algorithms include, but are not limited to edge detection, high/low energy detection based on a pixel color, a color shift, ranges of the pixel color, etc.

According to one embodiment, the pass filter 820 may further receive additional metadata including a depth data from an external device 862 such as a LiDAR, a radar, or a stereoscopic video camera. The depth data may be temporarily stored in a depth data buffer 851. The pass filter 850 can obtain more accurate results using both image data and the depth data under certain situations, for example, dark and low contrast scenes.

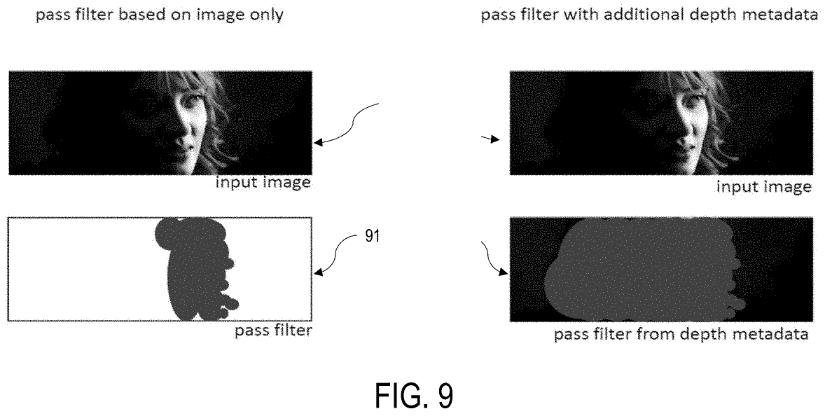

FIG. 9 shows comparative results of filtering using only image data and image data with depth data according one embodiment. The pass filter on the right side uses the image data and the depth data to generate an ROI of a personal profile under a low lighting condition with more accurately defined edges.

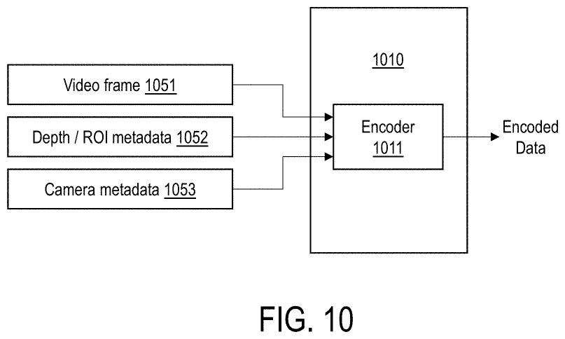

FIG. 10 shows a block diagram in which multiple data tracks are continuously fed to an apparatus for data compression, according to one embodiment. The apparatus 1010 may be used in a movie studio or an animation studio. The apparatus 1010 includes an encoder 1011 that is configured to encode video frames received from a video camera. The data fed to the encoder 1011 may include a first track 1051 of the raw video frames, a second track 1052 including depth/ROI metadata received from an external device, and a third track 1053 including camera metadata. The encoder 1011 combines the data received in the first, second, and third tracks 1051, 1052, and 1053 to encode the raw video frame and generate a data with a reduced size and/or a sampling frequency that may be different from the frequency of the raw video frame.

Camera metadata may include a camera's record pertinent technical information about a video frame, but not limited to, an aperture, a frame rate, a shutter speed, etc. For example, in a movie shooting, a metadata referred to as “pan and scan” determines how a movie director wants the movie to be presented on a different screen size/dimension from that in which it is originally shot. A good example of it is 4 by 3 aspect ratio TVs and airplane screens. The pan and scan data may be used to choose which part of the display screen shot should be displayed, and this may create a stream of metadata that enables the display of a window of the movie frame in the corresponding display screen. Later in a production cycle, more metadata may be added, for example, to cover synchronized subtitles or a program clock reference (PCR). These camera metadata may be synchronized to a primary video content in a production, a post processing, and/or a broadcasting of the video frame.

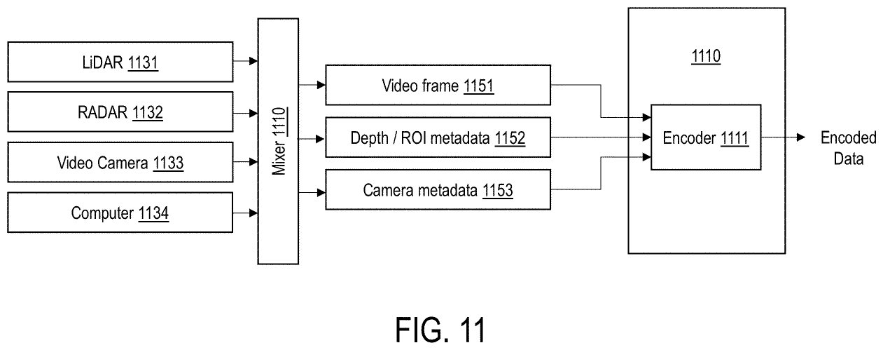

FIG. 11 shows a block diagram in which multiple devices feed data to a mixer for generating an encoded data, according to one embodiment. In an application where multiple devices provide data to an apparatus 1110 for encoding data, a mixer 1110 may be used to collect data from different data sources including, but not limited to, a LiDAR 1131, a radar 1132, a video camera 1133, and a computer 1134. The computer 1134 may add an object and its ROI to a video scene captured with the video camera 1133. The mixer 1110 may combine the video frame and the ROIs and feed the combined data to the encoder 1111 of the apparatus 1110 in multiple data tracks 1151, 1152, and 1153.

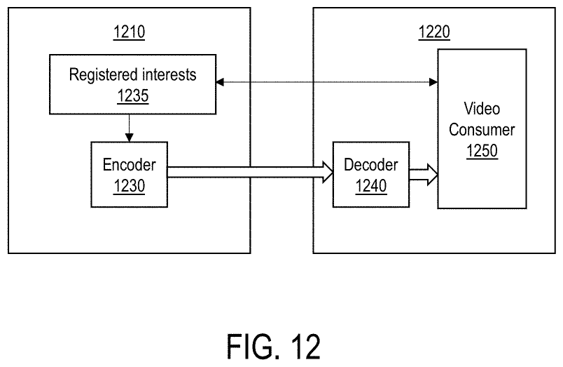

FIG. 12 shows a block diagram of an example system, according to one embodiment. A system 1200 includes a first electronic device 1210 and a second electronic device 1220. An encoder 1230 included in the first electronic device 1210 generates an encoded data and transfers it to a decoder 1240 of the second electronic device 1220. According to one embodiment, the first electronic device 1210 includes a list of registered interests 1235 that may be used to classify the ROIs when encoding the data using the encoder 1230. The list of registered interests 1235 may be updated based on a command received from a consumer (e.g., video consumer 1250 included in the second electronic device 1220). As discussed in FIGS. 10 and 11, the encoder 1230 encodes highly complex image data requiring a high bandwidth to generate the encoded data with reduced complexity and requiring a lower bandwidth. The encoded data may be transferred over to the second electronic device 1220 over is an interconnect such as PCIe, control area network (CAN) bus, or a proprietary data communication path. The decoder 1240 of the second electronic device 1220 decodes the data and feeds the decoded data to a video consumer 1250 for data consumption or further processing (e.g., DNN and CNN).

The present disclosure can be implemented in numerous ways, including as a process; an apparatus; a system; a composition of matter; a computer program product embodied on a computer readable storage medium; and/or a processor, such as a hardware processor or a processor device configured to execute instructions stored on and/or provided by a memory coupled to the processor. In this specification, these implementations, or any other form that the present disclosure may take, may be referred to as techniques. In general, the order of the steps of disclosed processes may be altered within the scope of the present disclosure. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the present disclosure is provided below along with accompanying figures that illustrate the principles of the present disclosure. The present disclosure is described in connection with such embodiments, but the present disclosure is not limited to any embodiment. The scope of the present disclosure is limited only by the claims and the present disclosure encompasses numerous alternatives, modifications and equivalents. Numerous specific details are set forth in the following description in order to provide a thorough understanding of the present disclosure. These details are provided for the purpose of example and the present disclosure may be practiced according to the claims without some or all of these specific details. For the purpose of clarity, technical material that is known in the technical fields related to the present disclosure has not been described in detail so that the present disclosure is not unnecessarily obscured.

According to one embodiment, an apparatus includes: an interface configured to receive an image data; a memory configured to store the image data; and a processor configured to run an application to determine one or more regions of interests (ROIs) within the image data. The processor generates a compressed image data by selectively applying a first data compression to the one or more ROIs and a second data compression to regions of the image data except the one or more ROIs.

The first data compression may be a lossless data compression, and the second data compression may be a lossy data compression.

Each of the one or more ROIs may be assigned with a priority based on physical closeness to the apparatus and may be applied with a varying level of data compression based on the priority.

Each of the one or more ROIs may be bounded by a bounding shape and may include an object, and the object may be one of a person, a vehicle, a traffic sign, and a traffic signal.

The bounding shape may expand or shrink based on a trajectory of the object.

The compressed image data may be generated at a frame rate that is different from a frame rate of the image data.

The processor may determine the one or more ROIs based on a depth map.

The depth map may be provided by a LiDAR, a radar, or a stereoscopic video camera.

The apparatus may encode the compressed image data and transfer the encoded compressed image data to an external device over a data communication path, and the external device may include a decoder to decode the encoded compressed image data.

The apparatus may further include a list of registered interests, and the external device may update the list of registered interests.

According to another embodiment, a method includes: receiving an image data; running an application to determine one or more regions of interests (ROIs) within the image data; and generating a compressed image data by selectively applying a first data compression to the one or more ROIs and a second data compression to regions of the image data except the one or more ROIs.

The first data compression may be a lossless data compression, and the second data compression may be a lossy data compression.

The method may further include: assigning a priority to each of the one or more ROIs based on physical closeness a camera that takes the image data; and applying a varying level of data compression to each of the one or more ROIs based on the priority.

Each of the one or more ROIs may be bounded by a bounding shape and may include an object.

The object may be one of a person, a vehicle, a traffic sign, and a traffic signal.

The bounding shape may expand or shrink based on a trajectory of the object.

The compressed image data may be generated at a frame rate that is different from a frame rate of the image data.

The method may further include: receiving a depth map from a LiDAR, a radar, or a stereoscopic video camera; and determining the one or more ROIs based on a depth map.

The method may further include: encoding the compressed image data; transferring the encoded compressed image data to an external device over a data communication path; and decoding the encoded compressed image data.

The method may further include: updating a list of registered interests by the external device; and determining the one or more ROIs based on the list of registered interests.

The above example embodiments have been described hereinabove to illustrate various embodiments of implementing a system and method for applying selective data compression schemes based on object classification and regions of interest. Various modifications and departures from the disclosed example embodiments will occur to those having ordinary skill in the art. The subject matter that is intended to be within the scope of the present disclosure is set forth in the following claims.

What is claimed is:

1. An apparatus comprising:
an interface configured to receive an image data;
a memory configured to store the image data; and
a processor configured to run an application to determine one or more regions of interests (ROIs) within the image data,
wherein the processor generates a compressed image data by selectively applying a first data compression to the one or more ROIs and a second data compression to regions of the image data except the one or more ROIs.

2. The apparatus of claim 1, wherein the first data compression is a lossless data compression, and the second data compression is a lossy data compression.

3. The apparatus of claim 1, wherein each of the one or more ROIs is assigned with a priority based on physical closeness to the apparatus and is applied with a varying level of data compression based on the priority.

4. The apparatus of claim 1, wherein each of the one or more ROIs is bounded by a bounding shape and includes an object, and wherein the object is one of a person, a vehicle, a traffic sign, and a traffic signal.

5. The apparatus of claim 4, wherein the bounding shape expands or shrinks based on a trajectory of the object.

6. The apparatus of claim 1, wherein the compressed image data is generated at a frame rate that is different from a frame rate of the image data.

7. The apparatus of claim 1, wherein the processor determines the one or more ROIs based on a depth map.

8. The apparatus of claim 1, wherein the depth map is provided by a LiDAR, a radar, or a stereoscopic video camera.

9. The apparatus of claim 1, wherein the apparatus encodes the compressed image data and transfers the encoded compressed image data to an external device over a data communication path, and the external device includes a decoder to decode the encoded compressed image data.

10. The apparatus of claim 9, wherein the apparatus further comprises a list of registered interests, and the external device updates the list of registered interests.

11. A method comprising:
receiving an image data;
running an application to determine one or more regions of interests (ROIs) within the image data; and
generating a compressed image data by selectively applying a first data compression to the one or more ROIs and a second data compression to regions of the image data except the one or more ROIs.

12. The method of claim 11, wherein the first data compression is a lossless data compression, and the second data compression is a lossy data compression.

13. The method of claim 11, further comprising:
assigning a priority to each of the one or more ROIs based on physical closeness a camera that takes the image data; and
applying a varying level of data compression to each of the one or more ROIs based on the priority.

14. The method of claim 11, wherein each of the one or more ROIs is bounded by a bounding shape and includes an object.

15. The method of claim 14, wherein the object is one of a person, a vehicle, a traffic sign, and a traffic signal.

16. The method of claim 14, wherein the bounding shape expands or shrinks based on a trajectory of the object.

17. The method of claim 11, wherein the compressed image data is generated at a frame rate that is different from a frame rate of the image data.

18. The method of claim 11, further comprising:
receiving a depth map from a LiDAR, a radar, or a stereoscopic video camera; and
determining the one or more ROIs based on a depth map.

19. The method of claim 11, further comprising:
encoding the compressed image data;
transferring the encoded compressed image data to an external device over a data communication path; and
decoding the encoded compressed image data.

20. The method of claim 11, further comprising:
updating a list of registered interests by the external device; and
determining the one or more ROIs based on the list of registered interests.
